(19) United States
(12) Patent Application Publication
(10) Pub. No.: US 2014/0033129 A1
(43) Pub. Date: Jan. 30, 2014

(54) COMPUTING DEVICE AND METHOD FOR CONTROLLING DESKTOP APPLICATIONS

(71) Applicants: HONG FU JIN PRECISION INDUSTRY (WuHan) CO., LTD., (US); HON HAI PRECISION INDUSTRY CO., LTD., New Taipei (TW)

(72) Inventor: HUNG-CHI HUANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/863,412

(22) Filed: Apr. 16, 2013

(30) Foreign Application Priority Data
Jul. 26, 2012 (TW) 101126896

(51) Int. Cl. G06F 3/0488

(52) U.S. Cl. CPC G06F 3/0488
USPC 715/835

(57) ABSTRACT

A method defines gesture types of touch events on a touch screen of a computing device, and sets associations between the gesture types and touch areas of the touch events and operation instructions stored within a storage device. The computing device displays a window of a desktop application on the touch screen. When a touch event is detected by the touch screen, the method records information in relation to the touch event, determines a touch area and a gesture type of the touch event by analyzing the information, determines an operation instruction corresponding to the touch event according to the touch area, the gesture type, and the preset associations, and executes the operation instruction to perform operations on the window of the desktop application.

### BACKGROUND

1. Technical Field

Embodiments of the present disclosure relate to information processing systems and methods, and more particularly to a computing device and a method for controlling desktop applications of the computing device.

2. Description of Related Art

Many operating systems support multi-touch screens. However, desktop applications under desktop interfaces are originally set up to respond to operations of a mouse, such as clicks or double-clicks performed on mouse buttons to operate icons or toolbars displayed on windows of the applications. Because these icons and toolbars are originally set up for a mouse, they are often very small, which brings inconvenience in touch operations towards the icons and toolbars of the desktop applications. For example, it may be difficult for a user to precisely touch a very small icon on a window of a desktop application, so that a mouse may still be necessary. Therefore, an improved method for controlling the desktop applications is desired.

### BRIEF DESCRIPTION OF THE DRAWINGS

FIG. 1 is a block diagram of one embodiment of a computing device including an applications controlling system.

FIG. 2 is a flowchart of one embodiment of a method for controlling desktop applications using the applications controlling system.

FIG. 3A-FIG. 3F illustrates gesture types defined by the applications controlling system.

FIG. 4 illustrates associations between the gesture types, touch areas of touch events on a touch screen of the electronic device and operation instructions stored within a storage device.

FIG. 5 shows a window of a desktop application that is displayed on the touch screen of the electronic device.

FIG. 6 illustrates determining of a touch area corresponding to a gesture type on the touch screen.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

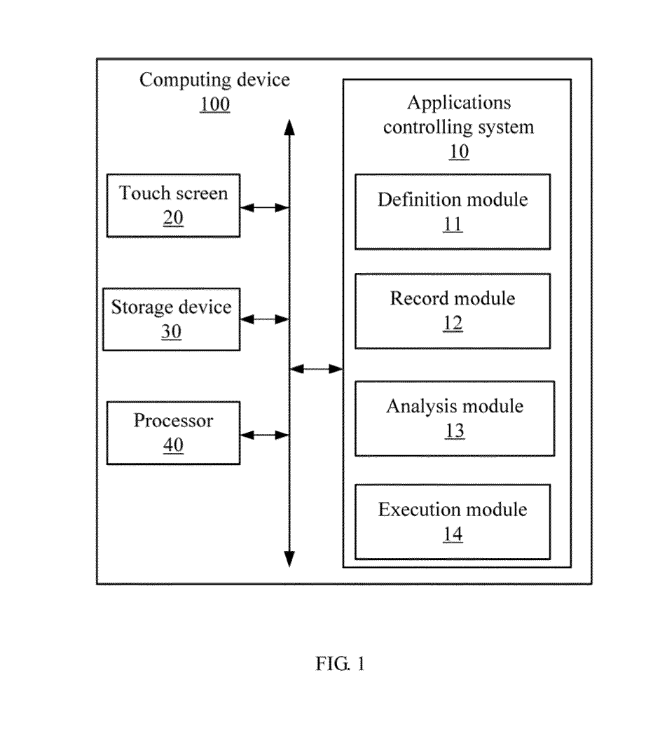

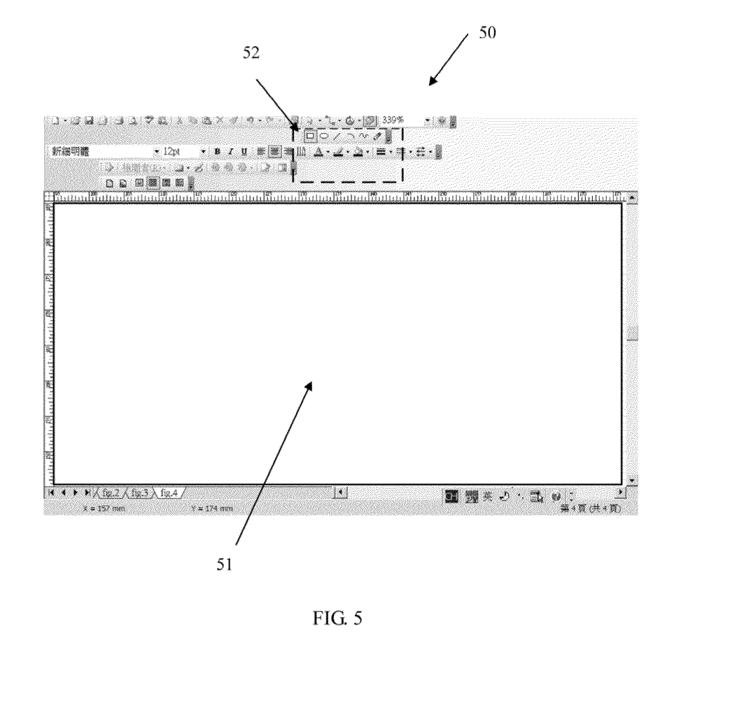

FIG. 1 is a block diagram of one embodiment of a computing device 100. The computing device 100 includes an applications controlling system 10, a touch screen 20, a storage device 30, and a processor 40. The storage device 30 stores computerized codes of one or more desktop applications. When a user selects and starts a desktop application, such as touching a shortcut of the desktop application displayed on the touch screen 20, the processor 30 executes computerized code of the selected desktop application, and displays a window (such as the window 50 shown in FIG. 5) of the selected desktop application on the touch screen 20.

The applications controlling system 10 defines gesture types of touch events detected by the touch screen 20, and sets associations between the gesture types, touch areas, and operation instructions stored within the storage device 30. When information of a touch event is detected by the touch screen 20, the applications controlling system 10 analyzes the information to determine a gesture type of the touch event and a touch area of the touch event, determines an operation instruction associated with the touch event according to the associations, the gesture type and the touch area, and executes the operation instruction to perform operations on a window of a desktop application that is displayed on the touch screen. In one embodiment, the information of the touch event includes coordinate information of contacts (e.g., a finger touching) on the touch screen 20 and time information when detecting the coordinate information. The operations performed on the window of the desktop application include minimizing, maximizing, and closing the window of the desktop application, and zooming in or zooming out of content (such as icons) displayed on the window of the desktop application.

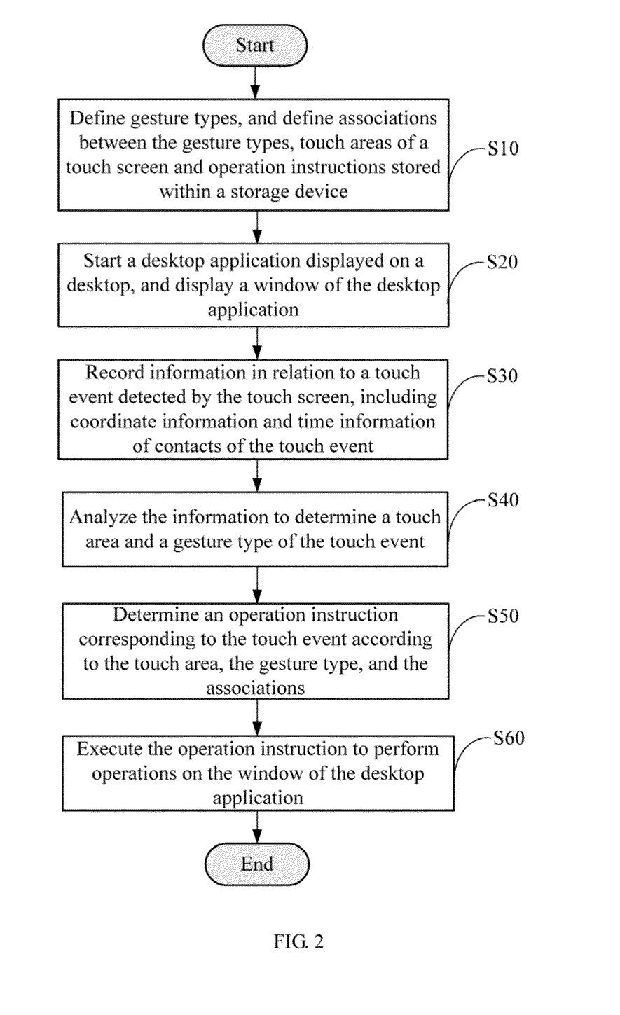

As shown in FIG. 1, the applications controlling system 10 includes a definition module 11, a record module 12, an analysis module 13, and an execution module 14. The modules 11-14 comprise computerized code in the form of one or more programs. Computerized code of the modules 11-14 is stored in the storage device 30, the processor 40 executes the computerized code to provide the aforementioned functions of the applications controlling system 10. Detailed functions of the modules 11-14 are referred to FIG. 2-FIG. 6.

FIG. 2 is a flowchart of one embodiment of a method for controlling desktop applications in the computing device 100. Depending on the embodiment, additional steps may be added, others removed, and the ordering of the steps may be changed.

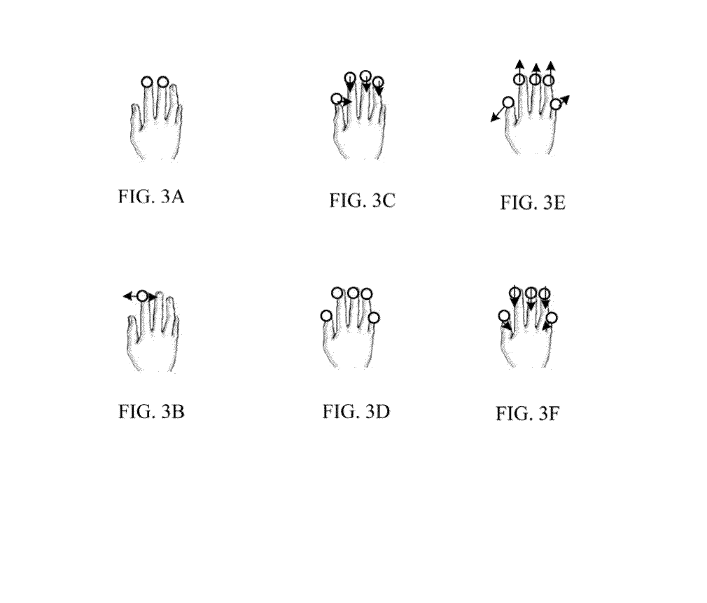

In step S10, the definition module 11 defines gesture types of touch events on the touch screen 20, and sets associations between the gesture types, touch areas of the touch events, and operation instructions stored within the storage device 30. For example, in this embodiment, six gesture types are defined by the definition module 11. As shown in FIG. 3A, a first gesture type is a double-click of a two-finger touch event on the touch screen 20 (e.g., the forefinger and the middle-finger touch the screen 20 at the same time). As shown in FIG. 3B, a second gesture type is a horizontal slide of a single-finger touch event on the touch screen 20 (e.g., the forefinger touches the touch screen 20 and slides from left to right). As shown in FIG. 3C, a third gesture type is an inward slide of a four-finger touch event on the touch screen 20 (e.g., the thumb, the forefinger, the middle-finger and the ring-finger touch the touch screen 20 and slide inwards). As shown in FIG. 3D, a fourth gesture type is a five-finger touch event over a preset time period (e.g., five seconds). As shown in FIG. 3E, a fifth gesture type is an outward slide of a five-finger touch event on the touch screen 20 (as shown in FIG. 3E). As shown in FIG. 3F, a sixth gesture type is an inward slide of a five-finger touch event on the touch screen 20.

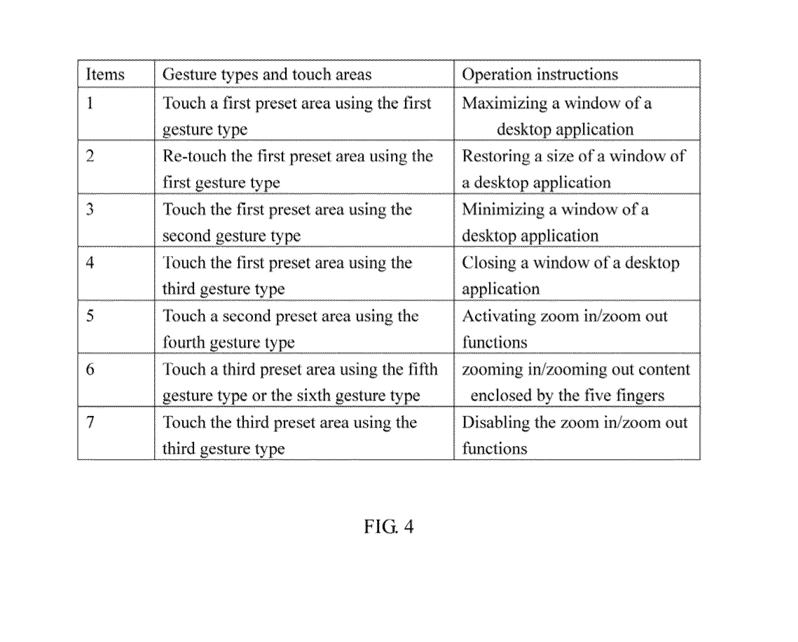

As shown in the table of FIG. 4, in this embodiment, the definition module 11 defines seven kinds of associations between the gesture types, the touch areas and the operation instructions. A first association is that touching a first preset area using the first gesture type corresponds to an operation instruction of “Maximizing a window of a desktop application.” A second association is that re-touching the first preset area using the first gesture type corresponds to an operation instruction of “Restoring a size of a window of a desktop application.” A third association is that touching the first preset area using the second gesture type corresponds to an operation instruction of “Minimizing a window of a desktop application.” A fourth association is that touching the first preset area using the third gesture type corresponds to an operation instruction of “Closing a window of a desktop application.” A fifth association is that touching a second preset area using the fourth gesture type corresponds to an operation instruction of “Activating zoom in/zoom out functions.” A sixth association is that touching a third preset area using the fifth gesture type corresponds to an operation instruction of “zooming in content enclosed by the five fingers,” and touching a third preset area using the sixth gesture type corresponds to an operation instruction of “zooming out content enclosed by the five fingers.” A seventh association is that touching the third preset area using the third gesture type corresponds to an operation instruction of “Disabling the zoom in/zoom out functions.”

In this embodiment, the first preset area is defined as a region on a window of a desktop application, where the region has no buttons that can be operated by an input device (such as a mouse) of the computing device 100, so that the first preset area will not respond to common touch operations representing common mouse operations (such as clicks or double-clicks using a single finger). For example, the first preset may be blank areas of a WORD window of a VISIO window (such as a drawing area 51 of the VISIO window 50 shown in FIG. 5). The second preset area is defined as any region on the touch screen 20, such as any part of the window of the desktop application, or an area on the touch screen excepting the window of the desktop application. The third preset area is defined as a region on the window of the desktop application which includes visible objects, such as toolbars and menus (such as a region 52 of the VISIO window 50 shown in FIG. 5).

In step S20, a desktop application is started and a window of the desktop application is displayed on the touch screen 20 (such as the VISIO window 50 shown in FIG. 5).

In step S30, the record module 12 records information in relation to a touch event detected by the touch screen 20, including coordinate information and time information of contacts of the touch event. The time information of a contact refers to when the contact is detected by the touch screen 20.

In step S40, the analysis module 13 analyzes the information in relation to the touch event to determine a touch area and a gesture type of the touch event. For example, if the analysis module 13 determines that the touch screen 20 first detects two simultaneous contacts with different coordinates, and further detects two other simultaneous contacts with different coordinates after a time period (such as three seconds), the analysis module 13 will determine that the touch event is of the first gesture type (as shown in FIG. 3A). If the analysis module 13 determines that the touch screen 20 detects five simultaneous contacts with different coordinates, and that the five contacts have a trend to expand away from each other, the analysis module 13 will determine that the touch event is of the fifth gesture type and determine the touch area according to the coordinates of the five contacts.

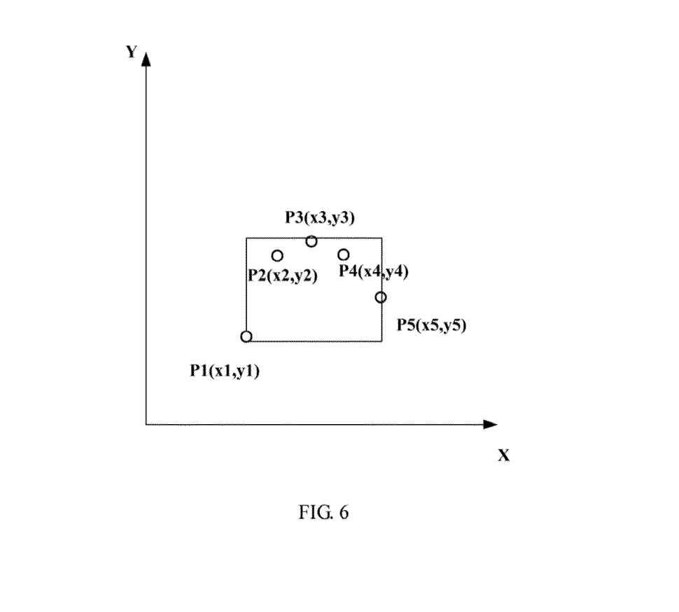

FIG. 6 illustrates determining the touch area according to the five contacts when the touch event is the five-finger touch event, either the fourth gesture type, the fifth gesture type, or the sixth gesture type. The five contacts include P1(x1,y1), P2(x2,y2), P3(x3,y3), P4(x4,y4), and P5(x5,y5), and the analysis module 13 determines a maximal x coordinate value Xmax and a minimal x coordinate value Xmin from x1-x5, determines a maximal y coordinate value Ymax and a minimal y coordinate value Ymin from y1-y5, and determines a rectangular area as the touch area according to Xmin, Ymin, Xmax, Ymax. As mentioned above, when the five-finger touch event is in the second preset area, the zoom in/zoom out function is activated, thus content displayed on the window of the desktop application which falls within the touch area may be zoomed in or zoomed out. A zoom ratio Z of the content falling within the touch area may be determined according to a zoom ratio ΔS of the touch area determined by the five contacts, such as Z=a×ΔS or Z=a×(ΔS)²+b×ΔS+c, where a, b, and c are constants.

In step S50, the analysis module 13 determines an operation instruction corresponding to the touch event according to the touch area, the gesture type, and the associations. For example, if the touch event is of the first gesture type and the touch area is the first preset area (such as the drawing area 51 of the VISIO window 50 shown in FIG. 5), the analysis module 13 determines that the operation instruction is “Maximizing a window of a desktop application” according to the associations shown in FIG. 4. If the touch event is of the five gesture type and the touch area is the third preset area (such as the region 52 of the VISIO window 50 shown in FIG. 5), the analysis module 13 determines that the operation instruction is “zooming in content enclosed by the five fingers” according to the associations shown in FIG. 4.

In step S60, the execution module 14 executes the operation instruction to perform operation on the window of the desktop application. For example, the execution module 14 may execute the operation instruction “Maximizing a window of a desktop application” to maximize the VISIO window shown in FIG. 5, or execute the operation instruction “zooming in content enclosed by the five fingers” to zoom in content (such as toolbars) contained within the region 52.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device for controlling desktop applications in the computing device, the method comprising:
defining gesture types of touch events on a touch screen of the computing device, and setting associations between the gesture types and touch areas of the touch events and operation instructions stored within a storage device;
displaying a window of a desktop application on the touch screen;
recording information in relation to a touch event detected by the touch screen, the information comprising coordinate information and time information of contacts of the touch event;
determining a touch area and a gesture type of the touch event by analyzing the information in relation to the touch event, and determining an operation instruction corresponding to the touch event according to the touch area, the gesture type, and the associations; and
executing the operation instruction.

2. The method of claim 1, wherein the gesture types comprise:
a double-click of a two-finger touch event on the touch screen, a horizontal slide of a single-finger touch event on the touch screen, an inward slide of a four-finger touch event on the touch screen, a five-finger touch event over a preset time period, an outward slide of the five-finger touch event on the touch screen, and an inward slide of the five-finger touch event on the touch screen.

3. The method of claim 2, wherein setting associations comprises:
setting the double-click of the two-finger touch event on a first preset area of the touch screen associated with an operation instruction of maximizing the window of the desktop application;
setting a twice double-click of the two-finger touch event on the first preset area of the touch screen associated with an operation instruction of restoring the window of the desktop application;
setting the horizontal slide of the single-finger touch event on the first preset area of the touch screen associated with an operation instruction of minimizing the window of the desktop application; and
setting the inward slide of the four-finger touch event on the first preset area of the touch screen associated with an operation instruction of closing the window of the desktop application.

4. The method of claim 3, wherein setting associations further comprises:
setting the five-finger touch event over the preset time period on a second preset area of the touch screen associated with an operation instruction of activating zooming in/zooming out functions;
setting the outward slide of the five-finger touch event on a third touch area of the touch screen associated with an operation instruction of zooming in content on the window of the desktop that falls within the third touch area, and setting the inward slide of the five-finger touch event on the third touch area of the touch screen associated with an operation instruction of zooming out the content on the window of the desktop that falls within the third touch area; and
setting the inward slide of the four-finger touch event on the third preset area of the touch screen associated with an operation instruction of disabling the zooming in/zooming out functions.

5. The method of claim 3, wherein the first preset area is defined as a region on the window of the desktop application, and the region has no button to be operated by an input device of the computing device.

6. The method of claim 4, wherein the second preset area is defined as any region on the touch screen, and the third preset area is defined as a region on the window of the desktop application which contains visible objects.

7. A computing device, comprising:
a processor;
a touch screen that displays a window of a desktop application;
one or more programs stored in a storage device of the computing device and executed by the processor to perform a method, the method comprising:
defining gesture types of touch events on a touch screen of the computing device, and setting associations between the gesture types and touch areas of the touch events and operation instructions stored within a storage device;
recording information in relation to a touch event detected by the touch screen, the information comprising coordinate information and time information of contacts of the touch event;
determining a touch area and a gesture type of the touch event by analyzing the information in relation to the touch event, and determining an operation instruction corresponding to the touch event according to the touch area, the gesture type, and the associations; and
executing the operation instruction.

8. The computing device of claim 7, wherein the gesture types comprise:
a double-click of a two-finger touch event on the touch screen, a horizontal slide of a single-finger touch event on the touch screen, an inward slide of a four-finger touch event on the touch screen, a five-finger touch event over a preset time period, an outward slide of the five-finger touch event on the touch screen, and an inward slide of the five-finger touch event on the touch screen.

9. The computing device of claim 8, wherein setting associations comprises:
setting the double-click of the two-finger touch event on a first preset area of the touch screen associated with an operation instruction of maximizing the window of the desktop application;
setting a twice double-click of the two-finger touch event on the first preset area of the touch screen associated with an operation instruction of restoring the window of the desktop application;
setting the horizontal slide of the single-finger touch event on the first preset area of the touch screen associated with an operation instruction of minimizing the window of the desktop application; and
setting the inward slide of the four-finger touch event on the first preset area of the touch screen associated with an operation instruction of closing the window of the desktop application.

10. The computing device of claim 9, wherein setting associations further comprises:
setting the five-finger touch event over the preset time period on a second preset area of the touch screen associated with an operation instruction of activating zooming in/zooming out functions;
setting the outward slide of the five-finger touch event on a third touch area of the touch screen associated with an operation instruction of zooming in content on the window of the desktop that falls within the third touch area, and setting the inward slide of the five-finger touch event on the third touch area of the touch screen associated with an operation instruction of zooming out the content on the window of the desktop that falls within the third touch area; and
setting the inward slide of the four-finger touch event on the third preset area of the touch screen associated with an operation instruction of disabling the zooming in/zooming out functions.

11. The computing device of claim 9, wherein the first preset area is defined as a region on the window of the desktop application, and the region has no button to be operated by an input device of the computing device.

12. The computing device of claim 10, wherein the second preset area is defined as any region on the touch screen, and the third preset area is defined as a region on the window of the desktop application which contains visible objects.

13. A non-transitory computer-readable medium having stored thereon instructions that, when executed by a processor of a computing device, causing the processor to perform a method comprising:
defining gesture types of touch events on a touch screen of the computing device, and setting associations between the gesture types and touch areas of the touch events and operation instructions stored within a storage device;
displaying a window of a desktop application on the touch screen;
recording information in relation to a touch event detected by the touch screen, the information comprising coordinate information and time information of contacts of the touch event;
determining a touch area and a gesture type of the touch event by analyzing the information in relation to the touch event, and determining an operation instruction corresponding to the touch event according to the touch area, the gesture type, and the associations; and
executing the operation instruction to perform operations on the window of the desktop application.

14. The medium of claim 13, wherein the gesture types comprise:
a double-click of a two-finger touch event on the touch screen, a horizontal slide of a single-finger touch event on the touch screen, an inward slide of a four-finger touch event on the touch screen, a five-finger touch event over a preset time period, an outward slide of the five-finger touch event on the touch screen, and an inward slide of the five-finger touch event on the touch screen.

15. The medium of claim 14, wherein setting associations comprises:
setting the double-click of the two-finger touch event on a first preset area of the touch screen associated with an operation instruction of maximizing the window of the desktop application;
setting a twice double-click of the two-finger touch event on the first preset area of the touch screen associated with an operation instruction of restoring the window of the desktop application;
setting the horizontal slide of the single-finger touch event on the first preset area of the touch screen associated with an operation instruction of minimizing the window of the desktop application; and
setting the inward slide of the four-finger touch event on the first preset area of the touch screen associated with an operation instruction of closing the window of the desktop application.

16. The medium of claim 15, wherein setting associations further comprises:
setting the five-finger touch event over the preset time period on a second preset area of the touch screen associated with an operation instruction of activating zooming in/zooming out functions;
setting the outward slide of the five-finger touch event on a third touch area of the touch screen associated with an operation instruction of zooming in content on the window of the desktop that falls within the third touch area, and setting the inward slide of the five-finger touch event on the third touch area of the touch screen associated with an operation instruction of zooming out the content on the window of the desktop that falls within the third touch area; and
setting the inward slide of the four-finger touch event on the third preset area of the touch screen associated with an operation instruction of disabling the zooming in/zooming out functions.

17. The medium of claim 15, wherein the first preset area is defined as a region on the window of the desktop application, and the region has no button to be operated by an input device of the computing device.

18. The method of claim 16, the second preset area is defined as any region on the touch screen, and the third preset area is defined as a region on the window of the desktop application which contains visible objects.
